(19) United States
(12) Patent Application Publication
(10) Pub. No.: US 2025/0334169 A1
(43) Pub. Date: Oct. 30, 2025

(54) RESTRAINER OF RELATIVE MOTION AMONG CHAIN LINKS

(71) Applicant: Abdullah Othman Fallatah, Jeddah (SA)

(72) Inventor: Abdullah Othman Fallatah, Jeddah (SA)

(21) Appl. No.: 18/647,999

(22) Filed: Apr. 26, 2024

(51) Int. Cl. F16G 13/12; F16G 13/18

(52) U.S. Cl. CPC F16G 13/12; F16G 13/18

(57) ABSTRACT

The present invention comprises a restrainer of relative motion among chain links which generally consisting of fastening arrangement installed on multiple links. In order for the desired restraint to occur, the chain must be straight in order for the two elements to be aligned with each other. Then, the first link in the chain is rotated around its vertical axis so the protuberant part enters in the groove which causes the movement to be restrained.

### FIELD OF THE INVENTION

The present invention relates to a modified type of link chain that is able to lock the relative movement between two chain links when the chain is straightened and make the entire chain behave like a solid bar if desired.

### BACKGROUND

Indispensable in practical applications, metal chains of all types have been an important piece of equipment to humanity since ancient times. People use chains in various fields such as: jewelry, lifting, fixation, power transmission and weapons. They are available in different sizes and shapes such as: oval, roller and twisted.

The design of the chain allows it to be flexible as it is made from connected links which can move relatively freely from each other. This design is also advantageous in storing chains as they do not require a significant area to be stored in when compared to alternative tools.

Fixation applications require a flexible tool that can be formed yet very resilient to withstand different kinds of load. Chains that are used to fix parts are usually subjected to fatigue load which is a repeated load that happens in cycles. A chain must endure this kind of load during shipping and securing heavy parts.

The prior art includes U.S. Pat. No. 8,056,315 which discloses chain connecting link, comprising: two link brackets having limbs to couple the link brackets with each other, wherein one of the limbs of each link bracket has a neck section and a pin of a thickness which is greater than a thickness of the neck section, and another one of the limbs has a neck recess and a pin recess of a contour to complement the neck section and the pin section, respectively, so that the pin of one of the link brackets is engageable in the pin recess of the other one of the link brackets and the neck section of the one of the link brackets is engageable in the neck recess of the other one of the link brackets, wherein the pin of one of the limbs and the pin recess of the other one of the limbs of each link bracket define a vertical central longitudinal plane and have first flank surfaces which are inclined with respect to the vertical central longitudinal plane; and a bar transversely arranged between the link brackets to lock the coupled link brackets.

In lifting, the chain is subjected to axial load which occurs always when it is used to lift something up. It happens naturally due to the resistance to gravitational force and it is translated to weight. For that reason, sellers of chains have to demonstrate the weight capacity of each one of them.

However, there is a problem with lifting by chains in the prior art. The only thing that keeps the lifted part stable is its weight. So, whenever the part is too light in weight, wind current or other factors can make it very hard to execute handling work. Furthermore, when a place with no gravity whatsoever like space, the chain will be almost useless for lifting. Therefore, there is a need for a novel chain that is capable of fixing the lifted part in the required elevation. It must not be dependent on gravity so it can be used for fixation applications if desired. A further need in the modified chain is to be flexible in the normal condition and becomes rigid when needed. That will allow the chain user to lift the required part and then suspend it vertically. This feature is highly required in distance sensitive fields like welding and fitting.

### BRIEF SUMMARY OF THE INVENTION

The invention is related to a traditional chain link. The invention comprises two connected links with a practical modification. One of the two links has an additional part for fixation purposes which settles on a groove in the other link. The way to move the extended part towards the slot is by rotating one of the links around its longitudinal axis while the chain is straightened. That will prevent the links from moving in each vertical direction therefore, a secured elevation and fixation will be achieved. According to an aspect of the present invention, there is provided a non-permanent mechanical fastening system for chain links, comprising: a first link; a second link; a protuberant part in the first link; and a groove in the second link, wherein: the protuberant part in the first link is configured to settle on a groove in the other link.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 shows an example of a perspective side view of a typical chain link.

FIG. 2—FIG. 2 illustrates an example of a perspective side view of a chain link with the restrainer according to various embodiments of the present invention.

FIG. 3—FIG. 3 depicts an example of a front view of a chain link with the restrainer according to various embodiments of the present invention.

FIG. 4—FIG. 4 shows a bottom view (A) and a cross-sectional bottom view (B) of a chain link with the restrainer according to various embodiments of the present invention.

FIG. 5—FIG. 5 illustrates a loose chain that is not subjected to load with multiple links with restrainers according to various embodiments of the present invention.

FIG. 6—FIG. 6 depicts a chain under a load with multiple links with restrainers where each link settles in the next restrainer according to various embodiments of the present invention.

FIG. 7—FIG. 7 shows a chain under a load with multiple links with restrainers while the first link rotated around its axis to lock the vertical movement according to various embodiments of the present invention.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence of additional one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Movement restrictor chain links are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

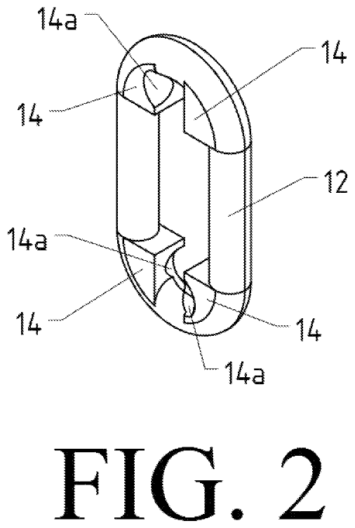

The present invention will now be described by referencing the appended figures representing preferred embodiments. FIG. 1 shows an example of a perspective side view of a typical chain link. In preferred embodiments, there is a singular typical link 12 which is the general form of chains link. However, FIG. 2 illustrates an example of a perspective side view of a chain link with restrainers according to various embodiments of the present invention. Restrainer 14's main purpose is to lock the movement by securing the two contacted links together. That is achieved with the help of the configured groove 14a which matches the link shape. The groove's purpose is to accommodate the link when a fixation is needed.

Restrainers 14 design are not limited to the embodiment shown in figures and explained herein. Another embodiment of restrainer can be a key with key bit that are inserted in a grooved hole in the other link when needed. After the pin is inserted, the link can be rotated to achieve the required locking. Restrainers 14 can be manufactured using casting while fixation grooves 14a can be machined by CNC machine. Any embodiments discussed in the present invention can be installed to the link using welding or chemical adhesive material or such methods.

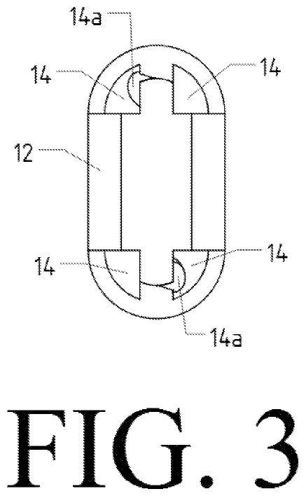

Referring to FIG. 3 depicts an example of a front view of a chain link with the restrainer according to various embodiments of the present invention. From another perspective, restrainer 14 arrangements can be observed from another angle. They are designed to form a grip to the link in contact with the link that they are attached to when a braking force is required for certain applications.

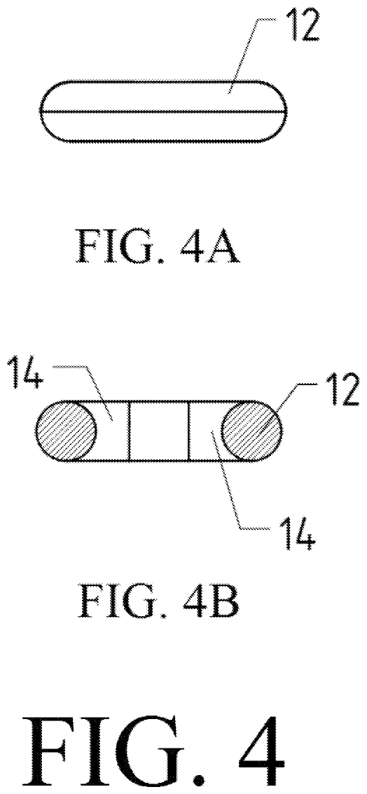

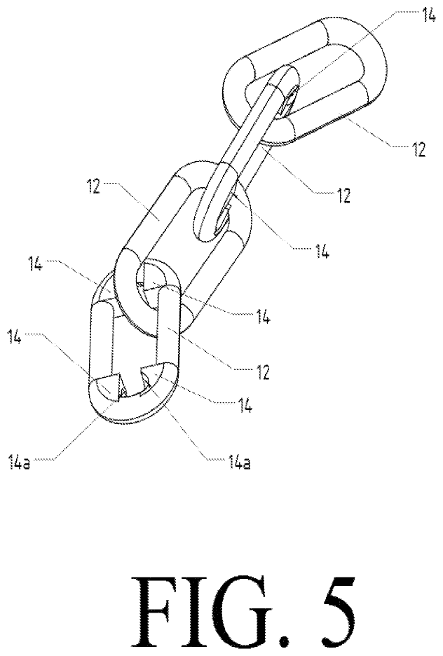

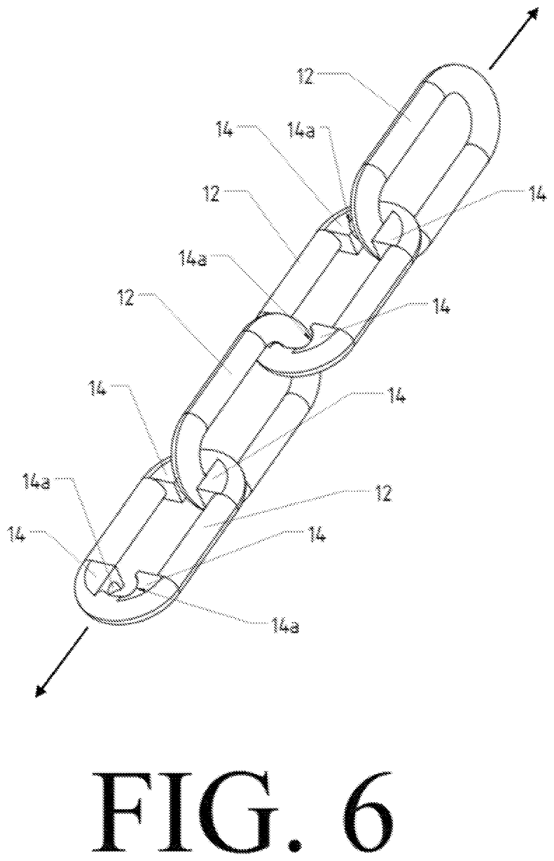

As shown in FIG. 4 a bottom view (A) and a cross-sectional bottom view (B) of a chain link with the restrainer according to various embodiments of the present invention. Restrainers 14 in FIG. 4A are not visible as they are smaller than link diameter. However, in the cross-sectional bottom view FIG. 4B restrainers 14 are visible with the gap between them. This gap allows the other link 12 to settle perpendicularly between the two restrainers 14 when the chain is fully straightened by applying a force at the two ends of the chain apart from each other as illustrated in FIG. 6.

FIG. 5 illustrates a loose chain that is not subjected to load with multiple links with restrainers according to various embodiments of the present invention. When the chain is not utilized, links are able to freely move in all directions. Regardless of its fixation purpose, the preferred embodiments of restrainers 14 allow this movement freedom to occur when a fixation is not needed. The modified link with restrainers 12 in FIG. 2 does not have a gripping force over the link 12 in FIG. 1 as long as the chain is not straightened. This feature is highly demanded as the main advantage of chains over other alternatives is the ability to store them in a relatively smaller area due to their flexibility. Also, some applications require the chain to be loose either permanently or temporarily.

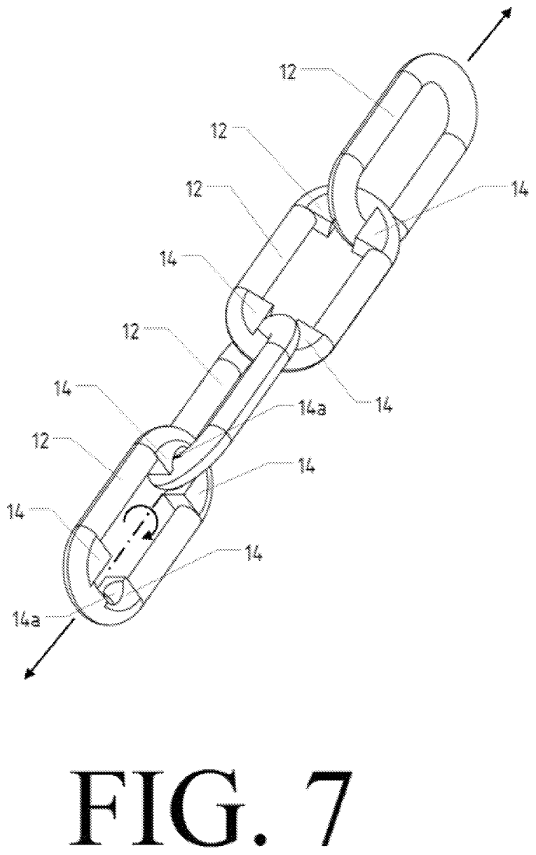

FIG. 6—FIG. 6 depicts a chain under a load with multiple links with restrainers where each link settles in the next restrainer according to various embodiments of the present invention. The chain can be straightened by pulling the last end in the opposite direction to the first end. Another way to achieve the elongated chain is to lift a significant weight against the gravity force using the chain. In any case, when an elongated structure occurs the ends of the chain link 12 settle in the gap between the two restrainers 14 without touching grooves 14a. This is a necessary step in the process since the next step shown in FIG. 7 cannot be achieved unless the end of the link 12 is exactly between restrainers 14.

FIG. 7 shows a chain under a load with multiple links with restrainers while the first link rotated around its axis to lock the vertical movement according to various embodiments of the present invention. When the chain is straight, the other step in the process can be done which is the rotation of the first link 12 around its axis. This is the most important step of the entire process as it makes the chain solid like a bar. When the first link 12 is rotated around the axis, it causes restrainers 14 to adhere the first link 12 with the second link which lead to form a mechanical connection between the two links as the end of second link engages in the two grooves 14a of restrainers 14 of the first link. Then, due to the torque of the rotation of the second link, a torque in the same direction will be formed which will cause a similar grip between the second link and the third link. Eventually, all links in the chain will turn in the same direction and they will freeze the relative motion of each other.

What is claimed is:

1. A non-permanent mechanical fastening system for chain links, comprising:
a first link;
a second link;
a protuberant part in the first link; and
a groove in the second link, wherein:
the protuberant part in the first link is configured to settle on a groove in the other link.

2. The non-permanent mechanical fastening system for chain links of claim 1, wherein the protuberant part inserts in the groove using a circular motion.

3. The non-permanent mechanical fastening system for chain links of claim 1, wherein the groove accommodates the protuberant part after the circular motion occurs.

4. The non-permanent mechanical fastening system for chain links of claim 1, wherein the protuberant part rotates one of the links around its longitudinal axis while the chain is straightened.

5. The non-permanent mechanical fastening system for chain links of claim 4, wherein rotation prevents the links from moving in each vertical direction.

6. The non-permanent mechanical fastening system for chain links of claim 5, wherein a secured elevation and fixation is achieved to restrain the relative motion among chain links.

7. The non-permanent mechanical fastening system for chain links of claim 1, further comprising a third link.

8. The non-permanent mechanical fastening system for chain links of claim 7, wherein when the first link is rotated around an axis, the first link to adheres the second link and due to the torque of the rotation of the second link, a torque in the same direction will be formed which will cause a similar grip between the second link and the third link.

9. The non-permanent mechanical fastening system for chain links of claim 8, further comprising one or more additional links.

10. The non-permanent mechanical fastening system for chain links of claim 9, wherein all links in the chain turn in the same direction and freeze the relative motion of each other.

11. The non-permanent mechanical fastening system for chain links of claim 1, wherein the chain links are oval.

12. The non-permanent mechanical fastening system for chain links of claim 1, wherein the chain links are roller.

13. The non-permanent mechanical fastening system for chain links of claim 1, wherein the chain links are twisted.

14. The non-permanent mechanical fastening system for chain links of claim 1, wherein the chain links are made of metal.

15. The non-permanent mechanical fastening system for chain links of claim 1, wherein the links are able to freely move in all directions when the protuberant part in the first link is not inside the groove in the second link.

16. A non-permanent mechanical fastening system for chain links of claim 1, wherein the protuberant part in the first link is a key and a key bit is inserted in the groove in the second link when needed.

17. A non-permanent mechanical fastening system for chain links of claim 16, wherein after the key bit is inserted, the link can be rotated to achieve the required locking.

18. The non-permanent mechanical fastening system for chain links of claim 1, wherein the protuberant part is manufactured using casting.

19. The non-permanent mechanical fastening system for chain links of claim 1, wherein the grooves are machined by a CNC machine.

20. The non-permanent mechanical fastening system for chain links of claim 1, wherein one or more of the protuberant part and the grooves are installed to the link using welding or chemical adhesive material or a similar method.
